(19) United States
(12) Patent Application Publication
(10) Pub. No.: US 2025/0013492 A1
(43) Pub. Date: Jan. 9, 2025

(54) COMPUTING APPARATUS, DATA PROCESSING METHOD, AND RELATED PRODUCT

(71) Applicant: Cambricon (Xi'an) Semiconductor Co., Ltd., Xi'an, Shaanxi (CN)

(72) Inventors: Linhui XIAO, Xi'an (CN); Liutao ZHENG, Xi'an (CN); Nan WANG, Xi'an (CN); Xin YU, Xi'an (CN)

(73) Assignee: Cambricon (Xi'an) Semiconductor Co., Ltd., Xi'an, Shaanxi (CN)

(21) Appl. No.: 18/694,686

(22) PCT Filed: Jun. 22, 2022
(86) PCT No.: PCT/CN2022/100303

§ 371 Date: Sep. 25, 2024

(30) Foreign Application Priority Data
Sep. 26, 2021 (CN) 202111131275.5

(51) Int. Cl. G06F 9/48; G06F 9/50

(52) U.S. Cl. CPC G06F 9/4881; G06F 9/5038

(57) ABSTRACT

The present disclosure discloses a computing apparatus, a method for processing data using the computing apparatus, and related products. The computing apparatus is included in a combined processing apparatus. The combined processing apparatus further includes an interface apparatus and other processing apparatus. The computing apparatus interacts with other processing apparatus to jointly complete a user specified computation operation. The combined processing apparatus further includes a storage apparatus. The storage apparatus is connected to the computing apparatus and other processing apparatus, respectively. The storage apparatus is used to store data of the computing apparatus and other processing apparatus. The scheme of the present disclosure achieves task slicing on a single core or multiple cores in the convolution operation, which improves the computational efficiency.

### CROSS REFERENCE OF RELATED APPLICATION

The present application claims priority to Chinese Patent Application No. 202111131275.5 with the title of “COMPUTING APPARATUS, DATA PROCESSING METHOD AND RELATED PRODUCT” and filed on Sep. 26, 2021.

### TECHNICAL FIELD

The present disclosure generally relates to a field of data processing. More specifically, the present disclosure relates to a computing apparatus, a method for processing data using the computing apparatus, a chip, and a board card.

### BACKGROUND

At present, deep learning has become an important branch of machine learning, and also vigorously contributes to the development of artificial intelligence (AI). Deep neural network (DNN), the core technology of deep learning, has been widely used in many industries.

Neural network is one of the most critical techniques in the artificial intelligence and deep learning, among which a convolution neural network (CNN) is one of the most important network types. The most critical computation in a convolution neural network is a convolution operation on a Conv (convolutional) layer. The function of the convolutional layer is to extract features from input data. By performing the convolution on a plurality of layers, complex features may be extracted to ensure that the network has powerful expression and generalization abilities. A neural network model contains a large number and various types of convolution operations, and the computational performance of the convolution operations greatly affects the computational performance of the entire neural network model. When the neural network model is applied to different fields, such as speech recognition, machine translation, image processing, and the like, their corresponding input feature maps and the size of each dimension of weights may vary. In order to take full advantage of hardware of a deep learning processor, it is necessary to optimize different scales, and different types of convolution operations to improve the computational performance of the neural network model.

### SUMMARY

In order to solve at least one or more technical problems as mentioned above, the present disclosure proposes, in various aspects, a computing apparatus which, by slicing a task of a convolution operation, may enable convolution operations of various scales to be adapted to hardware of the convolution operations, so as to improve the computational efficiency of the convolution operations. The convolution operations of embodiments of the present disclosure may be operations in various neural network models that may be applied to various fields, such as image processing, speech processing, text processing, and the like, where these processes may, for example, include, but are not limited to, identification and classification.

A first aspect of the present disclosure provides a computing apparatus, which includes a master device and a slave device, where the slave device includes one or more processor cores. The master device is configured to issue a first task for performing a convolution operation on input feature data and convolutional kernel data; and the slave device is configured to schedule an appropriate number of processor cores to execute the first task according to a slicing strategy of the first task, where in each core processing round, the convolution operation is performed on a part of the input feature data.

A second aspect of the present disclosure provides a chip including the computing apparatus described in the first aspect of the present disclosure.

A third aspect of the present disclosure provides a board card including the chip described in the second aspect of the present disclosure.

A fourth aspect of the present disclosure provides a method for processing data using the computing apparatus described in the first aspect of the present disclosure.

By adopting the computing apparatus, the chip, the board card, and the method for processing data using the computing apparatus as provided above, the scheme of the embodiments of the present disclosure provides an optimized solution for slicing convolutional computation tasks on a single-core or a multi-core computing apparatus to adapt to the processing capability of a hardware computing apparatus, thereby fully utilizing the parallel processing capability of a plurality of slave processing circuits, and effectively improving the computational efficiency of the convolution operation.

### BRIEF DESCRIPTION OF DRAWINGS

By reading the following detailed description with reference to accompanying drawings, the above-mentioned and other objects, features and technical effects of exemplary embodiments of the present disclosure will become easy to understand. In the accompanying drawings, several embodiments of the present disclosure are shown in an exemplary but not restrictive manner, and the same or corresponding reference numerals indicate the same or corresponding parts of the embodiments.

FIG. 1 illustrates a structural diagram of a board card according to an embodiment of the present disclosure.

FIG. 2 illustrates a structural diagram of a combined processing apparatus according to an embodiment of the present disclosure.

FIG. 3a illustrates a schematic diagram of an internal structure of a processor core of a single-core computing apparatus according to an embodiment of the present disclosure.

FIG. 3b illustrates a simplified schematic diagram of an internal structure of a multi-core computing apparatus according to an embodiment of the present disclosure.

FIG. 4 illustrates an example of an exemplary principle of a convolution operation that may be applied in an embodiment of the present disclosure.

FIG. 5 illustrates an exemplary structural block diagram of a computing apparatus according to an embodiment of the present disclosure.

FIG. 6 illustrates an exemplary data storage order according to an embodiment of the present disclosure.

FIG. 7a-FIG. 7c illustrate several exemplary group modes according to embodiments of the present disclosure.

FIG. 8 illustrates an exemplary schematic diagram of slicing an input feature map according to an embodiment of the present disclosure.

FIG. 9 illustrates an exemplary structural diagram of a computing apparatus that may implement embodiments of the present disclosure.

FIG. 10 illustrates a schematic diagram of slicing a neuron under different conditions according to an embodiment of the present disclosure.

### DETAILED DESCRIPTION OF EMBODIMENTS

Technical solutions in embodiments of the present disclosure will be described clearly and completely hereinafter with reference to accompanied drawings in the embodiments of the present disclosure. Obviously, embodiments to be described are merely some rather than all embodiments of the present disclosure. All other embodiments obtained by those of ordinary skill in the art based on the embodiments of the present disclosure without creative efforts shall fall within the protection scope of the present disclosure.

It should be understood that terms such as “first”, “second”, “third”, and “fourth” as they may appear in the claims, the specification, and drawings are used for distinguishing different objects rather than describing a specific order. It should be understood that terms “including” and “comprising” used in the specification and the claims indicate the presence of a feature, an entity, a step, an operation, an element, and/or an assembly, but do not exclude the existence or addition of one or more other features, entities, steps, operations, elements, components, and/or collections thereof.

It should also be understood that the terms used in the specification of the present disclosure are merely intended to describe specific embodiments rather than to limit the present disclosure. As being used in the specification and the claims of the disclosure, unless the context clearly indicates otherwise, singular forms “a”, “an”, and “the” are intended to include plural forms. It should also be understood that a term “and/or” used in the specification and the claims refers to any and all possible combinations of one or more of relevant listed items and includes these combinations.

As being used in this specification and the claims, a term “if” may be interpreted as “when”, or “once”, or “in response to a determination” or “in response to a case where something is detected” depending on the context.

### Exemplary Hardware Environment

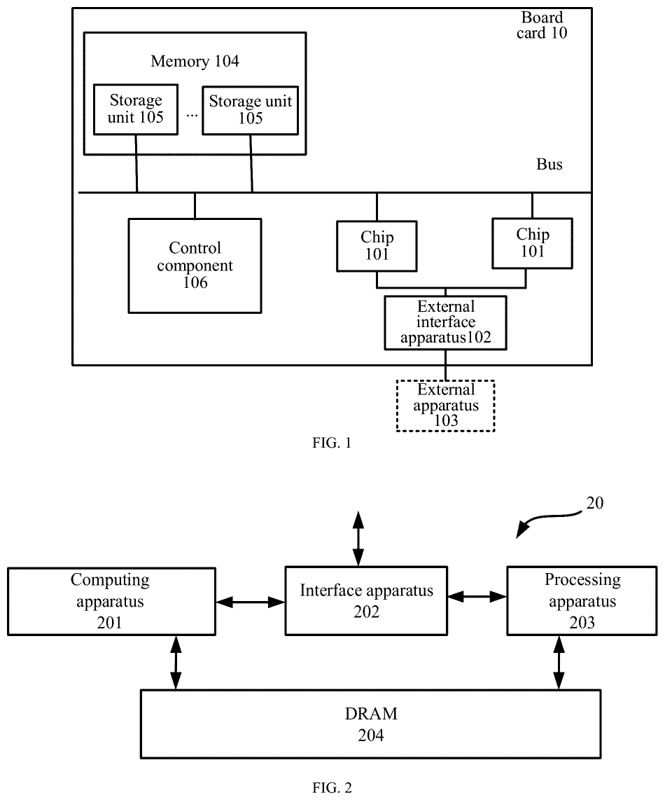

FIG. 1 is a structural diagram of a board card 10 according to an embodiment of the present disclosure. As shown in FIG. 1, the board card 10 includes a chip 101, which is an SoC (system-on-chip), or called an on-chip system. The chip 101 is integrated with one or more combined processing apparatuses. The combined processing apparatus is an artificial intelligence operation unit used to support various types of deep learning and machine learning algorithms to meet the intelligent processing requirements in complex circumstances in the fields of computer vision, speech, natural language processing, data mining, and the like. In particular, the deep learning technology is widely applied in the field of cloud intelligence. A prominent feature of the cloud intelligence application is the large amount of input data, which has high requirements on the storage capacity and computing power of a platform. The board card 10 of this embodiment is suitable for the cloud intelligence application due to its huge off-chip and on-chip storage and powerful computing capability.

The chip 101 is connected to an external apparatus 103 through an external interface apparatus 102. The external apparatus 103 may be, for example, a server, a computer, a camera, a monitor, a mouse, a keyboard, a network card, or a WIFI interface. Data to be operated may be transferred from the external apparatus 103 to the chip 101 through the external interface apparatus 102. A computation result of the chip 101 may also be transferred by the external interface apparatus 102 back to the external apparatus 103. According to different application circumstances, the external interface apparatus 102 may have different interface forms, such as a PCIe (peripheral component interconnect express) interface.

The board card 10 further includes a memory 104 used for storing data, which includes one or a plurality of storage units 105. The memory 104 may connect to and transfer data to a control component 106 and the chip 101 through a bus. The control component 106 in the board card 10 may be configured to regulate and control a state of the chip 101. As such, in an application circumstance, the control component 106 may include an MCU (micro controller unit).

FIG. 2 is a structural diagram of a combined processing apparatus in a chip 101 according to an embodiment of the present disclosure. As shown in FIG. 2, a combined processing apparatus 20 includes a computing apparatus 201, an interface apparatus 202, a processing apparatus 203, and a storage apparatus 204.

The computing apparatus 201 is configured to perform an operation specified by a user, and is mainly implemented as a single-core intelligent processor or a multi-core intelligent processor to perform deep learning computing or machine learning computing. The computing apparatus 201 interacts with the processing apparatus 203 through the interface apparatus 202 to jointly complete the operation specified by the user.

The interface apparatus 202 is used to transfer data and control instructions between the computing apparatus 201 and the processing apparatus 203. For example, the computing apparatus 201 may acquire input data from the processing apparatus 203 via the interface apparatus 202 and write the input data to an on-chip storage apparatus of the computing apparatus 201. Further, the computing apparatus 201 may acquire the control instructions from the processing apparatus 203 via the interface apparatus 202 and write the control instructions to an on-chip control cache of the computing apparatus 201. Alternatively or optionally, the interface apparatus 202 may further read data in the storage apparatus of the computing apparatus 201 and then transfer the data to the processing apparatus 203.

The processing apparatus 203 serves as a general-purpose processing apparatus, and performs basic controls that include, but are not limited to, moving data, starting and/or stopping of the computing apparatus 201. According to different implementations, the processing apparatus 203 may be one or more kinds of general-purpose and/or special-purpose processors, including a CPU (central processing unit), a GPU (graphics processing unit), and the like. These processors include but are not limited to a DSP (digital signal processor), an ASIC (application specific integrated circuit), an FPGA (field-programmable gate array), or other programmable logic devices, discrete gate or transistor logic devices, discrete hardware components, and the like. The number of the processors may be determined according to actual requirements. As described above, with respect to the computing apparatus 201 of the present disclosure only, the computing apparatus 201 of the present disclosure may be viewed as having a single-core structure or an isomorphic multi-core structure. However, when the computing apparatus 201 and the processing apparatus 203 are considered together, both the computing apparatus 201 and the processing apparatus 203 may be viewed as forming a heterogeneous multi-core structure.

The storage apparatus 204 is used for storing to-be-processed data, which may be a DRAM (dynamic random access memory). The storage apparatus 204 is a DDR (double data rate) memory with a size of 16 G or more than 16 G generally. The storage apparatus 204 is used for saving data of the computing apparatus 201 and/or the processing apparatus 203.

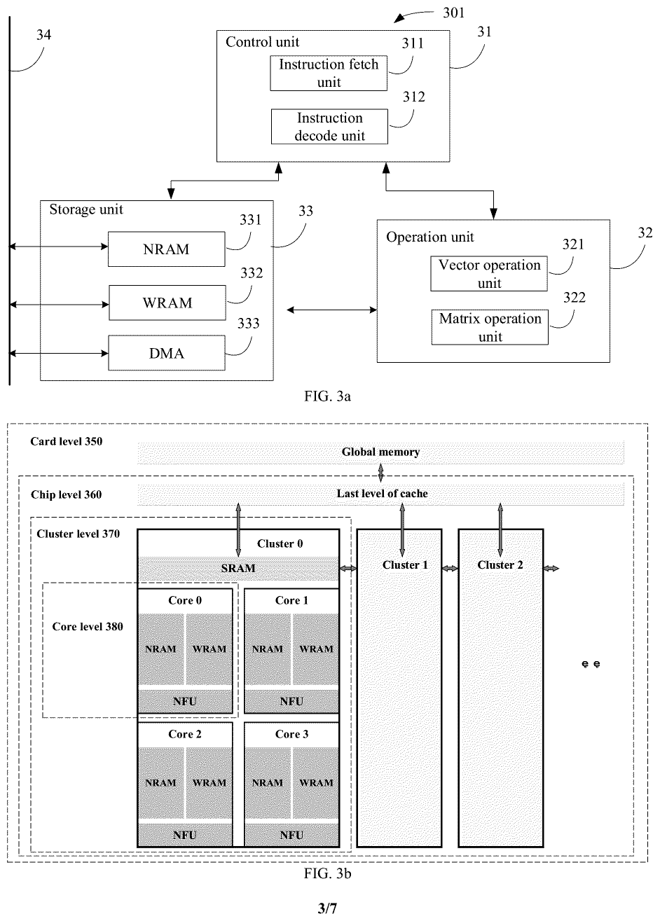

FIG. 3a illustrates a schematic diagram of an internal structure of a processor core of a computing apparatus 201 when it is a single-core apparatus. The computing apparatus 301 is configured to process input data in the fields of computer vision, speech, natural language, data mining, and the like. The computing apparatus 301 includes 3 units, which are a control unit 31, an operation unit 32, and a storage unit 33.

The control unit 31 is configured to coordinate and control the work of the operation unit 32 and the storage unit 33 to finish a deep learning task. The control unit 31 includes an IFU (instruction fetch unit) 311 and an IDU (instruction decode unit) 312. The instruction fetch unit 311 is configured to acquire an instruction from the processing apparatus 203. The instruction decode unit 312 is configured to decode the acquired instruction and send a decoding result as control information to the operation unit 32 and the storage unit 33.

The operation unit 32 includes a vector operation unit 321 and a matrix operation unit 322. The vector operation unit 321 is used to perform a vector operation, and may support complex operations such as vector multiplication, addition, and nonlinear transformation. The matrix operation unit 322 is responsible for the core computation of the deep learning algorithm, i.e., matrix multiplication and convolution.

The storage unit 33 is used to store or move relevant data and includes an NRAM (neuron RAM) 331, a WRAM (weight RAM) 332, and a DMA (direct memory access) 333. The NRAM 331 is used to store an input neuron, an output neuron and an intermediate result after computation; the WRAM 332 is used to store a convolutional kernel of a deep learning network, i.e., a weight; and the DMA 333 is connected to the DRAM 204 through a bus 34, and is responsible for data transfer between the computing apparatus 301 and the DRAM 204.

FIG. 3b illustrates a simplified schematic diagram of an internal structure of the computing apparatus 201 when it is a multi-core apparatus. A multi-core computing apparatus may be abstracted using a hierarchical hardware model. As shown in the figure, the multi-core computing apparatus may be abstracted into four levels, namely a card level (Card) 350, a chip level (Chip) 360, a processor cluster level (Cluster) 370, and a processor core level (Core) 380. In an embodiment of the present disclosure, the focus is on data transfer of the storage units and computing units, so the drawings and descriptions briefly illustrate and introduce relevant computational structures and omit other parts.

At the card level, each card includes a local DDR memory, and each processor chip serves as a computing and control unit.

At the chip level, each processor chip includes a plurality of processors as computing units.

At the processor cluster level, each processor includes a plurality of accelerator cores served as control and computing units and an SRAM served as a storage unit.

At the processor core level, each accelerator core includes a local memory and an array of local processing units, in other words, each accelerator core includes an NRAM, a WRAM, and an NFU (neuron function unit). An NFU is a neuron function unit, which is used for performing the convolution operation.

In the multi-core computing apparatus, a storage model includes a global memory on the card, an SRAM on the cluster, an NRAM, a WRAM, and a register on the core, and the like. To achieve better performance, the data transfer between the various storage levels below the card level and the balance between memory access and computation may be explicitly controlled. The SRAM is included in an MPU (memory process unit, or Mem Core). The Core refers to an intelligent process unit core in a multi-core computing apparatus, often abbreviated as IPU Core or Core. An IPU core includes an NRAM, a WRAM, an NFU, and the like, The Cluster refers to a processor cluster or a computing cluster. Usually a multi-core computing apparatus includes several clusters, and a cluster includes one Mem Core and N IPU Cores.

### Exemplary Type of Convolution Operation

The convolutional layer in a neural network model may perform a convolution operation. Specifically, by applying a convolutional kernel (also known as a filter, a weight, and the like) to an input feature map (also known as input data, a neuron, or an input neuron) to perform the convolution process, a feature extraction operation may be implemented. The convolutional layer may contain a plurality of convolutional kernels, and each element that makes up the convolutional kernel corresponds to a weight coefficient and a bias. The embodiments of the present disclosure may be applied to data slicing in various convolution operations.

In the conventional three-dimensional convolution operation, assuming that a tensor shape of the input feature map in the convolutional layer is denoted as X [N Hi Wi Ci], a tensor shape of the convolutional kernel is denoted as K [Co Kh Kw Ci], and an output result is Y [N Ho Wo Co], a simplified mathematical formula of the convolution operation may be expressed as:

$${Y}_{in , jc , jh , jw} = {\sum }_{0 \leq ic \leq ci , 0 \leq ih \leq kh , 0 \leq iw \leq kw} {X}_{in , ic , jh \times sh + ih , jw \times sw + iw} \times {K}_{jc , ic , ih , iw} \qquad ( 1 )$$

In the above formula, X is input data, Y is output data, K is a convolutional kernel, Kh is a length of K, Kw is a width of K, sh is a stride in the length direction, and sw is a stride in the width direction. The formula ignores bias, pad, and dilation, and assumes that the input data X has already been padded and the convolutional kernel has already been dilated. The formula ignores N and C dimensions; and forward computations of the neural network model are independent in the N dimension but fully connected in the C dimension. When the convolutional kernel is working, it may scan the input feature map according to a certain stride, and perform matrix elements multiplication and summation on the input feature map and superimpose the bias of a summation result in a convolutional window.

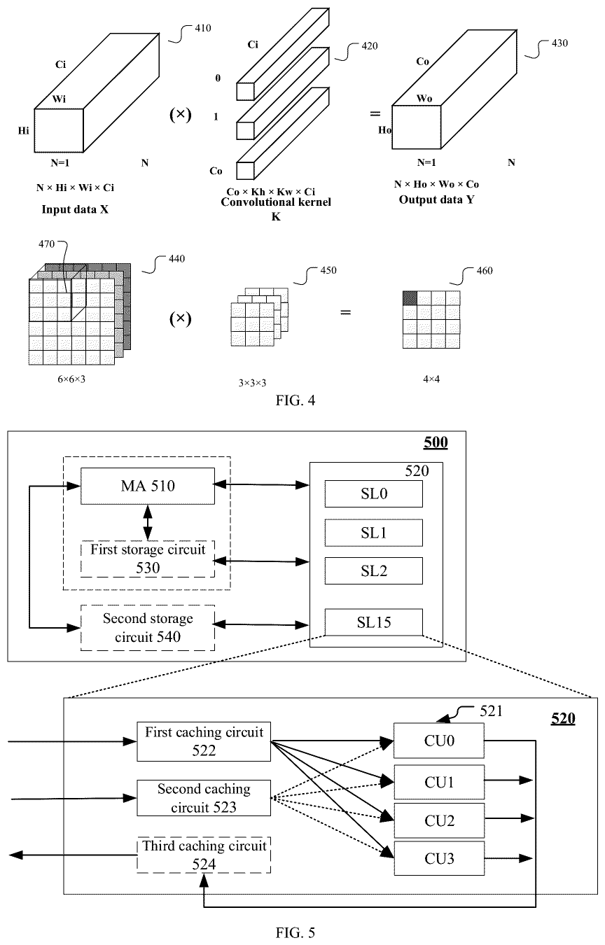

FIG. 4 illustrates an example of an exemplary principle of the conventional three-dimensional convolution operation that may apply an embodiment of the present disclosure.

A piece of four-dimensional input data X of size [N Hi Wi Ci] is exemplarily illustrated in the figure, which may be represented as N three-dimensional rectangles 410 of size Hi×Wi×Ci. A piece of four-dimensional convolutional kernel of size [Co Kh Kw Ci] is exemplarily illustrated in the figure, which may be represented as Co three-dimensional convolutional kernels 420 of size Kh×Kw×Ci. A convolutional result of the input data X and the convolutional kernel K is output data Y, which is four-dimensional data of size [N Ho Wo Co], and is represented as N three-dimensional rectangles 430 of size Ho×Wo×Co.

An exemplary convolution operation is also specifically illustrated in the figure, where the input data is an input feature map 440 of size 6×6×3, and the N dimension is omitted; the convolutional kernel is a three-dimensional convolutional kernel 450 of size 3×3×3, and there are total Co convolutional kernels; and the output data is a 4×4 output feature map 460. The specific computing procedure is as follows.

The convolutional kernel 450 may scan the input feature map 440 according to a certain stride, and perform matrix elements multiplication and summation on the input feature map and superimpose the bias of a summation result in a convolutional window 470. In other words, a value at each position in the output feature map 460 is obtained by performing a two-dimensional operation on a corresponding block of each input feature map and a corresponding convolutional kernel and summing the obtained convolutional results. For example, the figure illustrates that a value (i.e., a convolutional output point) at a position (0,0) on the output feature map 460 is obtained by performing a two-dimensional convolution operation on the convolutional window 470 framed by a black cube in the input feature map and the three-dimensional convolutional kernel 450 to obtain three values and summing the obtained three values.

To obtain outputs at other positions, a position of the convolutional kernel 450 may be shifted on the input feature map 440, in other words, a convolutional window of a convolutional output point may be shifted. In an example in the figure, a convolutional stride (Sx, Sy) is (1,1), and when the convolution operation is performed after moving one frame to the right in the horizontal direction (width direction) or moving one frame down in the vertical direction (height direction), a value at a position (0,1) or a value at a position (1,0) on the output feature map 460 may be obtained, respectively.

From the above description, it can be seen that in a convolutional layer of the neural network, there are N groups of input feature maps, and each group contains Hi×Wi×Ci pieces of information, where Hi and Wi are the height and width of the input feature maps, respectively, and Ci is the number of input feature maps, also known as the number of input channels. The convolutional layer has Ci×Co convolutional kernels of size Kh×Kw, where Ci is the number of input channels, Co is the number of output feature maps (or the number of output channels), and Kh and Kw are the height and width of the convolutional kernel, respectively. The output feature maps contain Ho×Wo×Co pieces of information, where Ho is a height of the output feature map, Wo is a width of the output feature map, and Co is the number of output channels. In addition, in the convolution operation, the convolutional stride (Sx, Sy) may also be involved, and the size of the convolutional stride may affect the size of the output feature map.

In the present disclosure, the input feature map, the input data, the neuron, or the input neuron are used interchangeably; and the convolutional kernel, the filter, or the weight are used interchangeably. In addition, the H (height) and the Y dimensions are used interchangeably, and the W (width) and the X dimensions are used interchangeably. Accordingly, the H dimension of the input feature map may be denoted as Hi or Yi, the H dimension of the output feature map may be denoted as Ho or Yo, and the W dimension is similarly denoted. In the embodiment of the present disclosure, each convolutional output point has a corresponding convolutional window, and a shape of the convolutional window is the same as a shape of the convolutional kernel. The value of each convolutional output point corresponds to a result of summing element-wise products of input feature maps and weights within the convolutional window of the convolutional output point.

### Exemplary Computing Apparatus/Data Processing Apparatus

In the embodiment of the present disclosure, a master-slave architecture computing apparatus may be used to implement the above convolution operation. Further, different data channels may be configured for input feature maps and convolutional kernels to improve access efficiency.

FIG. 5 illustrates an exemplary structural block diagram of a computing apparatus 500 according to an embodiment of the present disclosure. It may be understood that the structure may be considered as a detailed internal structure of a computing circuit of a single processor core as shown in FIG. 3a, or as a joint functional division block diagram based on the computing circuits of a plurality of processor cores as shown in FIG. 3a or FIG. 3b. As shown in FIG. 5, a computing apparatus 500 in an embodiment of the present disclosure may be configured to perform various types of convolution operations. The computing apparatus 500 may include a master processing circuit (MA) 510 and a plurality of slave processing circuits (SL) 520, and there are 16 slave processing circuits SL0 to SL15 illustrated in the figure. It may be understood by those skilled in the art that the number of slave processing circuits may be more or less, depending on the specific hardware configuration, and the embodiment of the present disclosure has no limitation in this respect.

The master processing circuit and the salve processing circuits may communicate with each other through various connections; and a plurality of salve processing circuits may communicate with each other through various connections. In different application circumstances, the connection methods between the plurality of salve processing circuits may be either a hard connection method arranged by a hard wire or a logical connection method configured according to, for example, a microinstruction, to form a variety of topological structures of arrays of slave processing circuits, which is not limited in the embodiment of the present disclosure. The master processing circuit and the slave processing circuits may cooperate with each other, thereby realizing a parallel operation.

To support the operation function, the master processing circuit and the slave processing circuits may include various computing circuits, such as a vector operation unit and a matrix operation unit. The vector operation unit is used to perform a vector operation, and may support complex operations such as vector multiplication, vector addition, and vector nonlinear transformation. The matrix operation unit is responsible for core computation of the deep learning algorithm, such as matrix multiplication and convolution.

The slave processing circuits may be used, for example, to perform an intermediate operation on corresponding data in parallel according to an operating instruction to obtain a plurality of intermediate results, and to transmit the plurality of intermediate results back to the master processing circuit.

By setting the computing apparatus 500 into a master-slave structure (such as a structure with one master processing circuit and multiple slave processing circuits, or a structure with multiple master processing circuits and multiple slave processing circuits, which is not limited in the present disclosure), data may be sliced according to a computing instruction of a forward operation, so that a plurality of salve processing circuits are used to perform parallel operations on the parts that require large amount of computation, thus improving the operation speed, saving the operation time, and then reducing the power consumption.

In some embodiments of the present disclosure, by utilizing different data channels to transmit input feature maps and weights, multiple ways of reusing input feature maps and weights may be supported, thus reducing the amount of data access during computation and improving processing efficiency.

Specifically, the computing apparatus 500 may further include a first storage circuit 530 and a second storage circuit 540 for storing data transmitted via different data channels, respectively.

The first storage circuit 530 may be used to store multicast data, in other words, data in the first storage circuit may be transmitted to a plurality of slave processing circuits via a broadcast bus, and the slave processing circuits receive the same data. It may be understood that broadcast and multicast may be achieved through the broadcast bus. The multicast refers to a communication mode where a piece of data is transmitted to a plurality of slave processing circuits; and the broadcast refers to a communication mode where a piece of data is transmitted the to all slave processing circuits. The broadcast is a special case of the multicast. Since both multicast and broadcast are one-to-many transmission modes, the present disclosure does not make a special distinction between the two. Both the broadcast and multicast may be collectively referred to as multicast, the meaning of which may be clarified by those skilled in the art based on the context.

The second storage circuit 540 may be used to store distribution data, in other words, data in the second storage circuit may be separately transmitted to different slave processing circuits, and each of the slave processing circuits receives different data.

By providing the first storage circuit and the second storage circuit separately, data to be operated may be transmitted in different modes, thereby reducing the amount of data access by reusing the multicast data among the plurality of slave processing circuits.

In some embodiments, the master processing circuit may determine one of the input feature maps and convolutional kernels as multicast data and store the multicast data into the first storage circuit to transmit the data to a plurality of scheduled slave processing circuits by the broadcast mode during operating. Correspondingly, the master processing circuit may determine the other of the input feature maps and the convolutional kernels as distribution data and store the distribution data into the second storage circuit. The distribution data may be distributed to corresponding slave processing circuits before operating.

FIG. 5 also illustrates a schematic diagram of an internal structure of a salve processing circuit SL according to an embodiment of the present disclosure. As shown in the figure, each slave processing circuit 520 may include a plurality of computing circuits CU 521, a first caching circuit 522, and a second caching circuit 523. Four computing circuits CU0 to CU3 are illustrated in the figure. It may be understood by those skilled in the art that the number of computing circuits may be more or less, depending on the specific hardware configuration, and the embodiment of the present disclosure has no limitation in this respect.

In some embodiments, the first caching circuit 522 may be used to cache weights or input feature maps assigned to the slave processing circuit. Accordingly, the second caching circuit 523 may be used to cache the input feature maps or weights assigned to the slave processing circuit. Both the first caching circuit 522 and the second caching circuit 523 are used to select data involved in the operation. Data of the first caching circuit 522 may be a plurality of data lines from, for example, the first storage circuit 530 or the second storage circuit 540; correspondingly, data of the second caching circuit 523 may be a plurality of data lines from, for example, the second storage circuit 540 or the first storage circuit 530. Depending on specific reusing methods, these data lines may be distributed to a corresponding computing circuit CU 521 or broadcast to all CUs 521 within the slave processing circuit 520 during operating.

Each of the computing circuits CU 521 is used to, in each computation, perform an element-wise product accumulation operation on data lines selected from the first caching circuit and data lines selected from the second caching circuit, respectively.

By providing the first caching circuit and the second caching circuit separately, data to be operated may be transmitted in different modes, thereby reducing the amount of data access by reusing the data among the plurality of computing circuits in a single slave processing circuit. The slave processing circuit 520 may also include a third caching circuit 524 for caching computation results of each computing circuit CU 521.

It may be understood that although each processing circuit and each storage circuit are shown as individual units in FIG. 5, the storage circuits and the processing circuits may also be combined into a single unit depending on the configuration. For example, the first storage circuit 530 may be combined with the master processing circuit 510; the second storage circuit 540 may be shared by the plurality of slave processing circuits 520, and each slave processing circuit may be allocated with a separate storage area for accelerating access, which is not limited in the embodiment of the present disclosure. In addition, in the computing apparatus, the master processing circuit and the salve processing circuits may belong to different units of the same processor or chip, or to different processors, which is not limited in the present disclosure.

### Exemplary Data Slicing and Storage

In an embodiment of the present disclosure, the dimensions of multidimensional data involved are represented as (N,H,W,C) or (Co,H,W,Ci), which represent the storage order of the data in the memory. It may be understood that although the multidimensional data has multiple dimensions, since the layout of the memory is always one-dimensional, there is a correspondence between the multidimensional data and the storage order of the memory. The multidimensional data is usually allocated in continuous storage space, in other words, the multidimensional data may be unfolded into a one-dimensional format and stored sequentially into the memory. For example, in the embodiment of the present disclosure, an initial input feature map may be stored sequentially in a low-dimensional (here C/Ci is the lowest dimension) prioritized manner. To optimize the convolution operation, the storage order of the input feature map may be adjusted during the operation, which will be described in detail later. Adjacent dimensions are dimensions that are next to each other in the dimensional information representation of multidimensional data, for example, W and Ci are adjacent to each other, and adjacent dimensions may also be referred to as contiguous dimensions.

In an intelligent processor, due to the requirements for computing power and considerations of area and power consumption, a main computing circuit of the hardware is a multiply-add operator for vectors. In hardware design, to support a variety of convolutional algorithms, the essence lies in maximizing the extraction of a multiply-add operation from the algorithms and efficiently exchanging input and output data of the multiply-add operation between an on-chip RAM (random access memory) (such as the NRAM and the WRAM in FIG. 3) and the operator via data channels.

Data is stored in the hardware line by line (cache line), and the efficiency of reading, writing, and computing is highest when aligned throughout the line, so in order to make full use of bandwidth and meet the access volume requirements of an operator array, data is typically vectorized and aligned. An artificial intelligence chip is usually designed with the Ci dimension as the lowest dimension, which is the above NHWC placement order, where the data in the Ci dimension is consecutive the data in the Ci dimension is consecutive. Thus, the vectorized alignment requires that the size of the Ci dimension is aligned to a specified value, such as an alignment value M, thereby accessing data in units of this alignment value M, where M may also be referred to as the maximum amount of data computed by the hardware at one time. Based on different hardware designs, M may have different values, such as 64 bit, 128 bit, 256 bit, 512 bit, and the like. Typically, the size of an input port of the operator array is also related to M. For example, when the bit width of the input data is symmetrical, the size of the input port of the operator array is usually 2 times that of M, which allows for the simultaneous processing of input feature map data and weight data of an alignment value of M at one time. It is easier to satisfy the above alignment requirement when the Ci dimension of the input feature map is large.

When the Ci dimension of the input feature map is small, for example, when the Ci dimension of the input feature map is less than the size of one cache line, the data in the Ci dimension is required to be padded to one line of data (such as 512 bits), in other words, invalid data 0 is required to be filled. This padding way results in a large number of redundant computations, leading to a waste of resources and a reduction in the operating efficiency.

In the embodiment of the present disclosure, a convolution operation scheme is proposed, which may determine a corresponding convolutional slicing scheme based on the size of the lowest storage dimension (such as the Ci dimension) of the input feature map, where the convolutional slicing scheme at least indicates a shape of a slicing unit of data to be operated. A slicing unit contains an amount of data that does not exceed the maximum amount of data that the hardware may process in a single operation.

In some embodiments, the amount of data contained in a slicing unit may be set to the alignment value M processed by the hardware at one time, so that the computation may be performed in units of a slicing unit, and in this way, the computing power of the hardware may be fully utilized to avoid or reduce invalid computation.

In the exemplary description of the present disclosure, it is assumed that M=512 bit=64 Byte, the data type may be Int8, Int16, Float16, or Float32, and the data types of the input feature maps and the convolutional kernels are consistent. Since the data type requires at least 1 byte in width and the smallest unit of computation is a piece of data, in the following examples, all computations are performed in units of bytes, for example, M=64B, Ci=28B, and sometimes the unit is omitted for simplicity.

When the amount of data contained in the slicing unit is equal to M, a shape of a data block of each slicing unit is blockC*blockY*blockX. There are various possible shapes for the data block. Table 1 lists several possibilities.

TABLE 1
Shape of data block

Data type

| Shape of data block | Int8 | Int16/ Float16 | Float32 |
|---|---|---|---|
| 64B × 1 × 1 | 64 × 1 × 1 | 32 × 1 × 1 | 16 × 1 × 1 |
| 32B × 2 × 1 | 32 × 2 × 1 | 16B × 2 × 1 | 8 × 2 × 1 |
| 16B × 2 × 2 | 16 × 2 × 2 | 8 × 2 × 2 | 4 × 2 × 2 |
| 16B × 4 × 1 | 16 × 4 × 1 | 8 × 4 × 1 | 4 × 4 × 1 |
| 8B × 4 × 2 | 8 × 4 × 2 | 4 × 4 × 2 | 2 × 4 × 2 |
| 4B × 4 × 4 | 4 × 4 × 4 | 2 × 4 × 4 | 1 × 4 × 4 |
| 4B × 8 × 2 | 4 × 8 × 2 | 2 × 8 × 2 | 1 × 8 × 2 |

From Table 1, it can be seen that X and Y dimensions of shapes of some data blocks (as shown in dark lines) are equal, and these shapes may simplify subsequent computations. Therefore, in the embodiment of the present disclosure, the data to be operated may be optimally sliced into this data block shape.

For simplicity, a scheme of slicing the data to be operated into the shape of 64B×1×1 is referred to as Forward64; a scheme of slicing the data to be operated into the shape of 16B×2×2 is referred to as Forward16; a scheme of slicing the data to be operated into the shape of 4B×4×4 is referred to as Forward4; in a depthwise convolution operation scenario, a scheme of slicing the data to be operated into the shape of 4B×4×4 is referred to as Forward1; in a reverse depthwise convolution operation scenario, a scheme of slicing the data to be operated into the shape of 4B×4×4 is referred to as Update1; and in a cross-multiply convolution operation scenario, a scheme of slicing the data to be operated into the shape of 4B×4×4 is referred to as Update4. In addition to the Forward64, these slicing schemes are suitable for a scenario where the channel C is relatively small in a convolution operation, hence these slicing schemes may be collectively referred to as “lite convolution”. In these lite convolution slicing schemes, a slicing unit includes data in the lowest storage dimension and data in at least one other storage dimension, and the total amount of data in a slicing unit does not exceed the maximum amount of data that the hardware may process in a single operation.

Different convolution slicing schemes may be applied to different computing circumstances, thereby achieving varying degrees of performance optimization.

After the slicing scheme is determined, according to the determined convolution slicing scheme, the input feature maps and convolutional kernels may be sliced into a plurality of corresponding slicing units, and the dimension storage order of the input feature maps and convolutional kernels may be transformed, so that data in a slicing unit is continuously stored as a data line, which is convenient for subsequent reading processing in units of a slicing unit (a data line).

In some embodiments, three-dimensional or four-dimensional neuron or weight data is sliced into data blocks with the size of blockC*blockY*blockX (Uc×Uy×Ux). Each data block is stored continuously in a line where, for example, M=64B. Therefore, when a line of data is read, data in a data block is actually extracted.

Specifically, one or more slicing units may be read in a first reading order in units of a slicing unit from data to be operated stored in a first dimension storage order, and then the read slicing unit may be stored in a corresponding storage circuit, where data in each slicing unit is stored in a second dimension storage order, and the slicing units are stored in a third dimension storage order between each other.

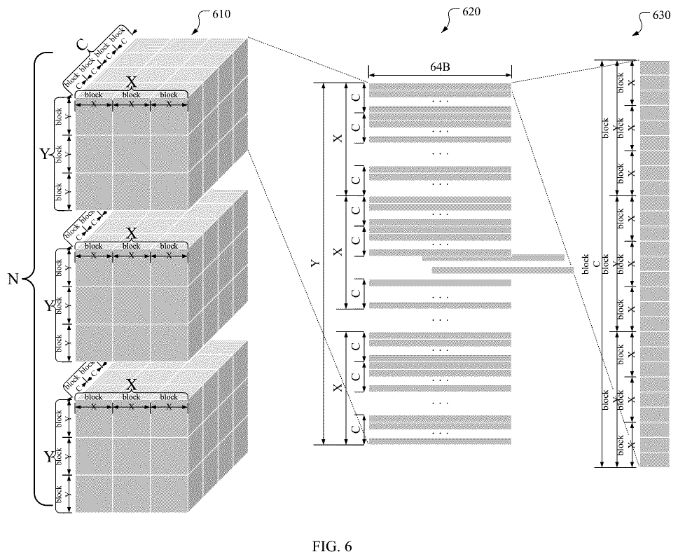

FIG. 6 illustrates an exemplary data storage order according to an embodiment of the present disclosure.

As shown in the figure, a diagram 610 illustrates a storage method of a four-dimensional tensor to be operated, which includes N three-dimensional sub-tensors, where N is the highest dimension, in other words, a first dimension storage order of the four-dimensional tensor is NHWC. Please note that in this text, H and Y, as well as W and X, may be used interchangeably. Each sub-tensor is sliced into smaller data blocks or slicing units, and the number of data blocks in each dimension is C/Y/X, respectively.

An intermediate diagram 620 illustrates a storage method of each sub-tensor, and each data block is stored as contiguous 64 bytes, i.e., a single line. When orders of reading the data blocks are different, orders between the lines will correspondingly change as well. In an example provided in the diagram, data blocks are read in an order of C first, then X, and finally Y; in other words, the first reading order is YXC. Consequently, the lines are stored in the order of Y*X*C, in other words, the third dimension storage order is YXC or HWC. In this example, the third dimension storage order is the same as the first dimension storage order. It is understood that other reading orders may be adopted, which may result in the third dimension storage order being different from the first dimension storage order, and this example will not list them all one by one.

A diagram 630 on the right illustrates an order within each line, i.e., a data order within each block, and a shape of the data block is blockC*block Y*blockX. At this time, the second dimension storage order is CYX or CHW.

### Exemplary Grouping Operation

The lite convolution is in the form of a block, and the advantage over traditional convolutions is that the alignment in the Ci direction only requires that the block is aligned in the Ci direction. In this scenario where the channel number is relatively small, weight size (co*Kh*kw*ci) is generally small, Kh and Kw are typically single-digit numbers, and co and ci are roughly the same. In the computing apparatus/data processing apparatus described in conjunction with FIG. 5, storage space of the second storage circuit (such as the WRAM 332 in FIG. 3) is usually larger than that of the first storage circuit (such as the NRAM 331 in FIG. 3). Therefore, to fully utilize on-chip computational space, for most lite convolution schemes, such as the Forward4, the Forward1, and the like, contrary to the traditional convolution, the storage positions of neurons and weights are swapped; in other words, neurons are stored in the second storage circuit WRAM and weights are stored in the first storage circuit NRAM.

A computation of convolution involves each input feature map undergoing multiply-add operations with each convolutional kernels for Co to output Co output feature maps. However, it is not always possible to store all sizes of convolutional kernels and input feature maps in on-chip space at the same time, so there are a series of repeated loading of input feature data or weight data on the hardware, and how to balance the repeated loading of input feature data or weight data may have a certain impact on the efficiency of the computation. In actual operations, to reduce frequent off-chip memory access, there is a slicing strategy for neurons and weights. In some embodiments, different slicing methods may be adopted according to scale characteristics of data involved in the operation.

According to the principle of the convolution operation described above, it can be seen that computation results in the Co dimension (the C dimension of a depth-wise convolution operation) are not required to be accumulated, and thus operations in different Cos may be performed relatively independently on different computing circuits. In a lite convolution scenario, typically in a single round of computation, the size of the Co dimension of a convolutional kernel does not exceed the number of slave processing circuits that are scheduled, so that the computation of a single Co is completed by one or more slave processing circuits. More generally, even when the Co dimension is larger, a lite convolution operation may be completed by slicing it into a plurality of rounds of computation, where the size of Co processed in each round does not exceed the number of slave processing circuits that are scheduled. Thus, in an example, the number of rounds of operations required to complete the lite convolution operation and the number of Co processed in each round or a corresponding group mode may be first determined based on the size of the Co dimension of the convolutional kernel and the number of slave processing circuits, Ns, that may be scheduled.

Regardless of allocation methods, there are two possible allocations of Co in a single round of operation: a plurality of slave processing circuits processing a single Co value, or a single slave processing circuit processing one or more Co values. Specifically, in a single round of operation for processing Nco output channels, each Rs of SLs may constitute a slave processing circuit group SLB for processing a convolutional kernel corresponding to a same output Co value, and Rs=[Ns/Nco]; in other words, the same convolutional kernel is reused over Rs of SLs within the same SLB, where Rs indicates the number of times that the convolutional kernel is reused among the slave processing circuits. Correspondingly, the input feature map may be reused among the slave processing circuit groups SLBs, where Rn=[Ns/Rs], which indicates the number of times that the input feature map is reused among the slave processing circuits.

Optionally or additionally, when each slave processing circuit processes convolutional kernels corresponding to rn Co values, where rn=[Nco/Ns], at this point, the input feature map processed by each slave processing circuit may be reused for rn convolutional kernels, where rn indicates the number of times that the input feature map is reused in a single slave processing circuit. Factors such as constraints on caching space of hardware (such as the size of the first caching circuit and the size of the second caching circuit in FIG. 5) may be considered to determine the maximum number of times that the convolutional kernel is reused in a single slave processing circuit, denoted as rs, and the maximum number of times that the input feature map is reused, denoted as rn.

Taking into account the limitations of cache size in hardware circuits and the benefits of reuse, in some embodiments disclosed herein, a scenario where a slave processing circuit processes multiple Co values in a single round of computation is temporarily not considered, and only a scenario where one or more slave processing circuits process only one Co value in a single round of computation is considered.

Depending on the number of slave processing circuits SL that process a same Co value in a single round of computation, different group modes may be adopted. It may be understood that, preferably, the available slave processing circuits SL are allocated evenly to balance the computing power. For example, every two SLs may be grouped together, allowing 16 SLs to simultaneously process 8 Co values; or every four SLs may be grouped together, allowing 16 SLs to simultaneously process 4 Co values, and so on. In the computing apparatus described in conjunction with FIG. 5, the second storage circuit WRAM has 16 storage areas, which are respectively allocated to 16 slave processing circuits SL. Furthermore, every 4 storage areas may be combined into a storage block, assigned to a corresponding slave processing circuit group SLB. Thus, in some embodiments, for the computing apparatus shown in FIG. 5, which includes Ns SLs, where Ns is equal to 16, several group modes may be selected: Group1 mode, Group 4 mode, and Group 16 mode. Those skilled in the art may understand that, depending on the value of Ns, there may be different group modes, and each grouping mode may be processed correspondingly by referring to the three representative group modes provided in the present disclosure.

In some embodiments, the aforementioned group modes may be uniformly represented as GroupN, indicating that in the current round of computation, all scheduled slave processing circuits SL are sliced into N groups, with each slave processing circuit group SLB processing a same Co value, and different slave processing circuit groups SLB processing different Co values. In a scenario where there are a total of 16 SLs available for scheduling, N may be 1, 4, or 16, corresponding to the Group1, Group 4, and Group16 modes described earlier respectively.

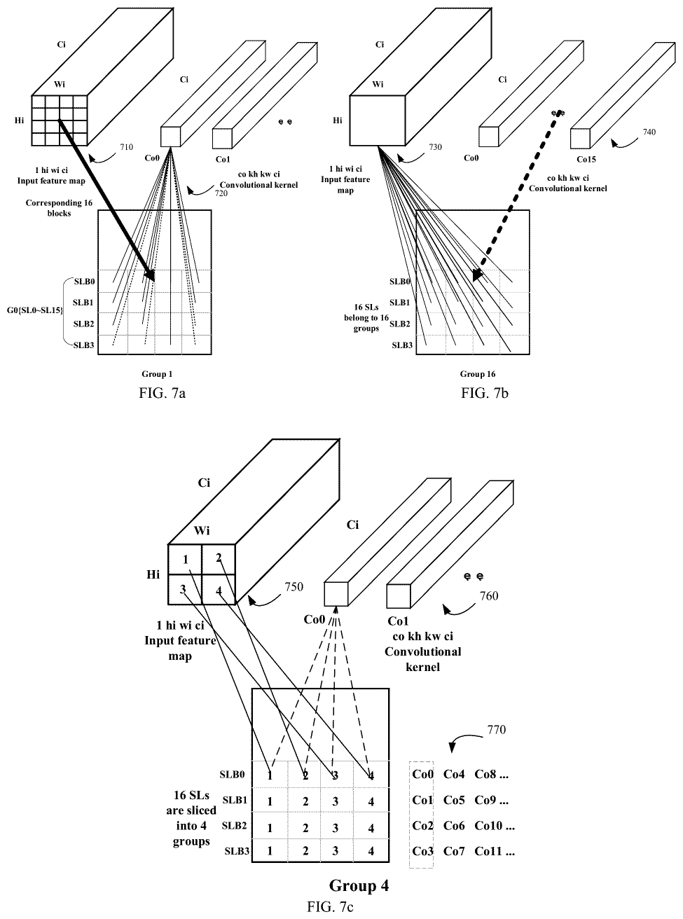

FIG. 7a-FIG. 7d illustrate several exemplary group modes according to embodiments of the present disclosure. FIG. 7a illustrates a Group1 mode, FIG. 7b illustrates a Group 16 mode, FIG. 7c illustrates a Group4 mode, and FIG. 7d illustrates another Group4 mode.

As shown in FIG. 7a, the Group1 mode refers to all 16 schedulable SLs belonging to one group and collectively processing a single Co value. For example, SL0 to SL15 belong to a group G0. Thus, the computation for one output channel is distributed over 16 SLs. In this mode, it is preferable to consider broadcasting a convolutional kernel 720 of the output channel to each SL and slicing and allocating an input feature map 710 to each SL, thereby improving memory access efficiency.

In an embodiment, the convolutional kernels are stored in the first storage circuit 530 as shown in FIG. 5 to take advantage of the broadcast channel for transfer. The input feature map may be sliced along the XY direction of an output feature map and stored in the second storage circuit 540 to be allocated to different SLs. Therefore, all SLs work together to compute an output feature map of one Co. The slicing and storage of the input feature map will be described in detail later in conjunction with the drawings.

As shown in FIG. 7b, the Group 16 mode refers to slicing all 16 schedulable SLs into 16 groups; in other words, one SL per group, with each SL processing a different Co value. For example, an SL0 belongs to a group G0, an SL1 belongs to a group G1, and so on, up to an SL15 belonging to a group G15. In this mode, a same input feature map 730 may be reused among the 16 SLs, so it may be prioritized to transmit the input feature map 730 to each SL in a broadcast manner, while the convolutional kernel 740 corresponding to different Co values is distributed to the respective SLs.

In an embodiment, the input feature map may be copied into 16 duplicates, stored on 16 storage areas allocated for 16 slave processing circuits on the second storage circuit. The convolutional kernel is sliced according to Co, with one SL corresponding to one Co, and 16 Cos are processed at a time. The sliced convolutional kernel is stored on the first storage circuit, and distributed to different SLs in a unicast manner. Therefore, all SLs compute output feature maps for different Co values based on a same input feature map.

As shown in FIG. 7c, the Group4 mode refers to slicing all 16 schedulable SLs into 4 groups, and one group processes a Co value. Each SL group (referred to as SLB) includes Rs SLs, where Rs=Ns/4=4. For example, SL0 to SL3 belong to a group G0, SL4 to SL7 belong to a group G1, SL8 to SL11 belong to a group G2, and SL12 to SL15 belong to a group G3. This mode lies between Group1 and Group16, hence either the convolutional kernels or the input feature maps may be designated as multicast data, while the other may be determined as distributed data.

In an embodiment, the convolutional kernels may be sliced into four groups according to Co, and the four groups of convolutional kernel are stored in the first storage circuit 530 as shown in FIG. 5 to take advantage of a broadcast channel for transfer. The input feature map may be sliced into 4 parts along the XY direction of the output feature map and copied 4 times, stored in the second storage circuit 540, and distributed to four SLBs. Each SLB receives a same input feature map, and within the SLB, the input feature map is then sliced into four parts and distributed to the four SLs within the SLB. Therefore, all SLs within each SLB collectively compute an output feature map of one Co, and four SLBs respectively process a different Co.

As shown in FIG. 7c, the convolutional kernels are sliced into four groups, specifically, convolutional kernels are sliced into each group based on Co with an interval of 1. For example, when Co=12, coordinates of the sliced four groups in the Co direction are as follows: {0,4,8}, {1,5,9}, {2,6,10} and {3,7,11}. Each time, one Co from each group is sent; for example, at the first time, Co=0˜3 is sent, with one Co corresponding to one SLB, and the four SLs within one SLB share a same weight; at the second time, Co=4˜7 is sent, and so on. Therefore, after each round of operation is completed, a Co dimension of a computation result output by each SLB is continuous.

When the Forward4, a lite convolution slice operation scheme, is adopted, to support all three modes simultaneously, neurons may be uniformly stored in the second storage circuit WRAM, and weights may be stored in the first storage circuit NRAM.

### Exemplary Slicing of an Input Feature Map

From the previous description, it can be seen that when a plurality of SLs process a single Co value, the input feature maps are required to be sliced among these SLs. For instance, in the Group 1 mode, the input feature maps are required to be sliced into 16 parts, while in the Group4 mode, the input feature maps are required to be sliced into 4 parts.

To ensure that the sliced input feature maps may share convolutional kernels, the slicing may be based on the Ho/Wo dimensions of the output feature map, which then maps back to the slicing of the input feature maps. In some embodiments, within Rs slave processing circuits included in each slave processing circuit group, the input feature maps may be sliced as follows: based on the size of a corresponding output feature map, the output feature map is evenly sliced into Rs output feature blocks of the same shape along the XY dimensions (i.e., Ho/Wo dimensions); and according to the region of the input feature maps required to compute each output feature block, the input feature maps are sliced into Rs input feature blocks along the XY dimensions (i.e., Hi/Wi dimensions) to be assigned to the Rs slave processing circuits. Understandably, depending on the size of the convolutional kernel and the convolutional stride, input feature maps corresponding to neighboring output points on the output feature map may overlap.

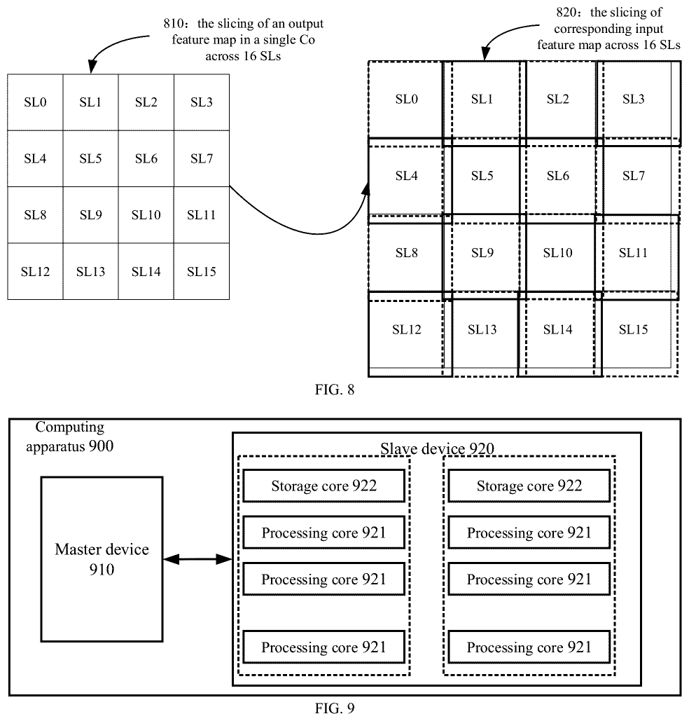

FIG. 8 illustrates an exemplary schematic diagram of slicing an input feature map according to an embodiment of the present disclosure. In this example, the input feature map is sliced into 16 parts and allocated on 16 SLs, corresponding to the Group1 mode.

In the figure, 810 represents an output feature map of a single Co, which is sliced into 16 output feature blocks with the same shape in the XY directions in a 4×4 manner, assigned to SL0S to L15 respectively. Subsequently, these 16 output feature blocks may be mapped back onto an input feature map 820, subsequently, 16 regions of the input feature map required to compute these 16 output feature blocks may be obtained repectively. The obtained input feature map is also sliced in the XY directions. These 16 regions of the input feature maps may be correspondingly allocated to 16 slave processing circuits.

According to the description provided, based on a determined convolution slicing scheme, the input feature map is sliced in units of a slicing unit. Therefore, in the aforementioned embodiment, the slicing of the input feature map must ensure that the size of each sliced input feature map block is a multiple of the size of the slicing unit in the XY directions; in other words, the size of each sliced feature map is aligned with the size of the slicing unit. For example, when a 4×4×4 convolution slicing scheme is selected, each input feature map block is aligned as 4×4; and when a 16×2×2 convolution slicing scheme is selected, each input feature map bock is aligned as 2×2.

For a case where the output feature map is not aligned with the slicing unit (such as 4×4 or 2×2), it is necessary to pad the input feature map accordingly (for example, 0 is used to pad the input feature map) to ensure that the size of an actual computed output in the XY dimensions is aligned with the slicing unit (such as 4×4 or 2×2), and the size of an input in the XY dimensions is also aligned with the slicing unit (such as 4×4 or 2×2).

It is understandable to those skilled in the art that the output feature map may also be sliced in the XY directions according to other rules, for example, the output feature map may be sliced into 16 identically shaped output feature blocks in a 1×16 manner, and the sliced output feature blocks are assigned to SL0˜SL15 respectively, which is not limited in the embodiment of the present disclosure. Additionally, it can be understood that, although the previous description is combined with the slicing among slave processing circuits, this slicing manner may also be applied to other scenarios, such as the slicing among computing circuits CU within a single slave processing circuit SL, which is not limited in the embodiment of the present disclosure.

### Exemplary Convolution Operation Process in a Single Slave Processing Circuit

After data to be computed is sliced and stored in a corresponding order, a plurality of slave processing circuits may be scheduled to perform convolution operations on corresponding data lines of the input feature maps and convolutional kernels. Subsequently, based on the convolution slicing scheme, computation results returned from the plurality of processing circuits may be concatenated to get an output feature map by performing the convolution operation on the input feature maps and the convolution kernels. Specifically, a plurality of computing circuits CUs as well as individual caching circuits in a slave processing circuit (please refer to FIG. 5) may be utilized to perform specific convolution operations. Depending on the space size of the caching circuits within the slave processing circuit and the computing power limit of the computing circuits, it is usually necessary to perform multiple operation cycles in each round of operation to complete the operation.

From the previous description, it is known that in conventional three-dimensional convolution operation scenarios, all computing circuits within a single slave processing circuit compute an output feature map or some output feature maps corresponding to a same output channel Co. Depending on the space size of the first caching circuit and the second caching circuit within the slave processing circuit SL, and the processing power (such as an internal register) of the computing circuit CU, the slave processing circuit may not be able to compute the output feature map allocated to it all at once. Therefore, the output feature map may be sliced into output feature blocks based on the computing capacity of a computing circuit in a single computation (for example, the computing circuit computes Nop output points or partial sums in a single computation). Each output feature block corresponds to the computing capacity (NNct*Nop output points) of all schedulable Neu computing units within a single SL in a single computation. For example, taking an example in FIG. 5 where each SL includes 4 CUs, assuming that each CU may compute Nop=4 output points or partial sums of output points in a single computation, then a single SL may compute 4*4=16 output points (or partial sums) in a single computation. Therefore, the output feature map may be sliced into output feature blocks aligned with 16 output points in XoYo dimensions, and each output feature block may be computed one by one. It is understandable that these 16 output points may be arranged in a 4×4 format or a 1×16 format, which is not limited in the embodiments of the present disclosure.

When each sliced output feature block is computed, output points of the output feature block may be further sliced among these Neu computing units to determine processing targets for each computing unit. Then, based on the slicing of the output points, using the slicing unit as a sliding window, Neu input feature data lines are selected from the first caching circuit and distributed to Neu computing circuits, and corresponding weight data is selected from the second caching circuit and broadcast to Neu computing circuits, so that a parallel computation of output points corresponding to a plurality of sliding windows may be realized by reusing the weight data. Nk times of sliding window selection may be performed, where Nk is determined based on a smaller value of the size of the convolutional kernel in the X and Y dimensions and the size of a maximum convolutional kernel supported by the slave processing circuit under a current convolution slicing mode in a single computation.

In some embodiments, when a conventional three-dimensional convolution operation is performed, corresponding weight data may be selected as follows: 1/Nop weight lines are selected from the second caching circuit in a sliding window selection manner corresponding to the first caching circuit; and the selected 1/Nop weight lines are replicated Nop-1 times to be extended into an expanded weight line and broadcast to the Net computing circuits in the slave processing circuit.

At this time, each computing circuit may, during each sliding window selection process, perform the element-wise multiplication and accumulation on one input feature line from the first caching circuit and one expanded weight data line from the second caching circuit using 1/Nop data lines as the unit to obtain Nop partial sums. Additionally, the Nk*Nop partial sums obtained by performing Nk times of sliding window selection may be accumulated according to corresponding convolutional output points to obtain and output Nop computation results.

The processing circuits, when outputting the output points from its internal computing units, may output the output points computed by a plurality of computing units in a specific order according to the slicing manner of the output points, which ensures that the consecutively outputted output points are continuous in the X and/or Y dimension, facilitating subsequent processing. In some embodiments, the master processing circuit may further store computation results returned from each slave processing circuit in a fourth dimension storage order. Depending on situations, the master processing circuit may also store the computation results in a desired dimension storage order.

The slicing of output points among computing circuits may be performed in various ways, and accordingly, the sliding window selection and convolution process and the output order of the output points will also differ.

### Slicing Schemes of Convolution Operation Tasks on Single-Core/Multi-Core Computing Apparatus

Various methods of performing convolution operations within a single processing core are described above, including group modes and slicing methods within those groups.

When the lite convolution operation scheme is adopted, since the slicing unit is used as the computing unit, there are inevitably alignment constraints during the computation. Depending on different group modes, and different H*W slicing methods under a same group mode, the alignment constraints during the computation are also different finally. For the computation of alignment, the alignment constraints of ho*wo may be determined first based on the slicing method of the output feature map, and then hi*wi may be obtained by inverting ho*wo back. Since input neurons are required to be set in the form of slicing unit blocks, an alignment operation is required to be performed one more time. Taking Forward4 as an example, which uses a 4B*4*4 block as a computing unit, the aforementioned alignment constraints may be summarized in the following Table 2:

TABLE 2
Alignment Constraints

| Alignment | | | |
|---|---|---|---|
| constraints | Group1 | Group4 | Group16 |
| Output (ho, wo) | 4 × 4 slicing: 16 * 16 | 1 × 4 slicing: 4 * 16 | no slicing in the ho |
| | 1 × 16 slicing: 4 * 64 | 2 × 2 slicing: 8* 8 | and wo directions: |
| | | | 4*4 |
| Input (hi*wi*ci) | int8: 4 * 4 * 4 | int8: 4 × 4* 4 | int8: 4 * 4 * 4 |
| | half: 4 * 4 * 2 | half: 4 * 4 * 2 | half: 4 * 4 * 2 |
| | float: 4* 4 * 1 | float: 4 * 4 * 1 | float: 4 * 4 * 1 |
| Convolutional kernal | Computation | Computation | Computation |
| (kh, kw) | alignment 2*2 | alignment 2*2 | alignment 2*2 |
| | Slicing unit | Slicing unit | Slicing units |
| | alignment 4*4 | alignment 4*4 | alignment 4*4 |
| Input channel (ci) | 4B | 4B | 4B |
| Output channel (co) | 1 | 4 | 16 |

When the convolution operation is performed on the multi-core computing apparatus, for example, referring to the simplified schematic diagram of the multi-core structure shown in FIG. 3b, at the cluster level, a cluster has 4 accelerator cores, and a computation of each core is independent yet related to each other.

According to the alignment constraints in the different Group modes and different H*W slicing methods of Forward4 shown in the table above, it can be known that there are certain alignment constraints on hi and wi during the Forward4 computation. If logical slicing on data during the convolution operation is not considered, it will lead to excessive alignment when the Cluster distributes data to the Core, resulting in wasted computing power, and additionally, it will also bring complexity to the data blocking during the computation.

Further, as mentioned earlier, the Forward4 has a clear advantage when processing the input feature maps that have large HW (height and width) dimensions. However, when the HW dimensions of the input feature maps are small, the advantage is less pronounced due to alignment issues. In light of this, consideration may be given to a convolution operation scenario where the HW dimensions of the input feature maps are relatively large. In this scenario, the C dimension is often relatively small; for example, in a first conv scenario, the C dimension is typically 4. In this scenario, it is often unnecessary to consider a case where the on-chip space cannot accommodate all the channels.

Based on the aforementioned analysis, in order to accommodate alignment constraints while ensuring the correctness of the computation, the embodiments of the present disclosure propose a strategy for slicing input feature maps in a case where the HW dimensions of the input feature maps are relatively large. The slicing strategy here involves slicing irregular and differently shaped input feature maps (neural tensors) into basic blocks that may be computed for computation.

The provided slicing strategy may be applied to a multi-core computing apparatus; for example, the slicing strategy is adopted for determining the slicing of the input feature maps in multiple cores (in different space). The provided slicing strategy may be applied on a single-core computing apparatus, for example, the slicing strategy is adopted for determining the slicing of the input feature maps in a single core at different time rounds.

FIG. 9 illustrates an exemplary structural diagram of a computing apparatus according to an embodiment of the present disclosure. As shown in FIG. 9, a computing apparatus 900 includes a master device 910 and a slave device 920, where one or more processor cores 921 may be included in the slave device 920.

The master device 910, for example, may be a general-purpose processor, which serves as a control device (referred to as a host), responsible for complex control and scheduling tasks. The master device 910, for example, may be the processing apparatus 203 shown in FIG. 2. The slave device 920, for example, may be various domain-specific processors, responsible for large-scale parallel computation or domain-specific computational tasks. The slave device 920, for example, may be the computing apparatus 201 shown in FIG. 2. The master device 910 and the slave device 920 work in coordination to complete the computational tasks.

In some embodiments, the computing apparatus may be configured to perform the convolution operation. Specifically, the master device 910 may be configured to issue a first task. The first task is to perform the convolution operation on the input feature data and the convolutional kernel data. Preferably, in these convolution operation circumstances, the size of the Ci dimension of the input feature data and the convolutional kernel data is less than a first threshold, and either the size of the width W or the size of the height H of the input feature data exceeds a second threshold. The first threshold, for example, may be 64B, 32B, and the like, so that the on-chip space may accommodate all channels of data. The second threshold, for example, may be a multiple of 4, 8, 16, or even 64, thereby padding data for the channel dimension or facilitating grouping and slicing.

The slave device 920 may schedule an appropriate number of processor cores 921 to execute the first task according to the slicing strategy of the first task. During each core processing round, the aforementioned convolution operation is performed on a portion of the input feature data.

As described earlier, the slicing strategy may be applied to both multi-core and single-core computing apparatuses. Therefore, the term “core round” mentioned in the present disclosure may refer to the computational rounds of a single core at different times, as well as the computational rounds of different cores at the same time.

Therefore, in some embodiments, the master device 910 may determine a slicing strategy of the first task. Whether on the multi-core computing apparatus or the single-core computing apparatus, the aforementioned slicing strategy may be determined by the core rounds of processing cores required to complete the first task, as well as the number of input feature blocks required to be processed in each core round. Here, “core round” refers to a total number of processing rounds of all processing cores to complete a task, which means the expansion of a corresponding task in spatial or temporal dimensions.

The slave device 920 may also include one or more storage cores 922, each of which may be shared by one or more processing cores 921 to store data before, during, and/or after processing by the processing cores. For example, for a single-core board card, a one storage core+one processing core architecture is generally adopted; and for a multi-core board card, a one storage core+N processing cores architecture is adopted, where N could be, for instance, 4.

The master device may determine the slicing strategy based on the scale of the input feature data. Let's assume that the shape of a piece of input feature data is [N, H, W, C], where N represents a batch dimension, H is a height dimension, W is a width dimension, and C is an input channel dimension. The shape of a piece of output feature map data is [Ho Wo Co].

Considering that computations between batches are relatively independent, in some embodiments, the master device may first determine a slicing strategy based on the total number of batches B of the input feature data and the total number of schedulable processing cores Ncore.

Specifically, the master device may determine the number of processing rounds L, as well as the number of batches Bi processed in each round, where i=1, . . . , L, and L=ceil (B/Ncore), Σᵢ₌₁^{L}Bi=B. In other words, batches may be evenly distributed across Ncore processing cores.

In an example, when the total number of batches B is a multiple of the total number of cores Ncore, every consecutive n batches of input feature data may be assigned to a single processing core for processing, where n=B/Ncore. Consequently, each processing core may process consecutive batches of data.

When the total number of batches B is not an integer multiple of the total number of cores Ncore, for example, when B=n*Ncore+Brem, where n=L−1, and Brem<Ncore, in other words, Brem batches are assigned to Ncore processing cores, a plurality of cores are required to process a same batch of data. It can be understood that when B=1, in other words, data is in a single batch, there may still be a scenario where the single batch is sliced and processed across a plurality of processing cores.

Considering that processing cores in the multi-core computing apparatus are typically divided in a manner of computing clusters for management, in some embodiments, the processing of a single batch may be sliced based on the computing clusters.

Specifically, in an example, the master device may distribute Brem batches of input feature data across a plurality of computing clusters for processing, with Ne computing clusters working together to process the input feature data of a same batch.

Data slicing among computing clusters may take various approaches. In some embodiments of the present disclosure, considering that the input feature map has a small C dimension but large HW dimensions, the data slicing among computing clusters may be executed based on the HW dimensions.

In an example, the master device may slice the output feature data corresponding to the input feature data in a convolution operation into Ne equally shaped output feature blocks along the first dimension; and based on the input feature region required to compute each output feature block, the input feature data is correspondingly sliced into Nc input feature blocks along the first dimension and allocated to the aforementioned Nc computing clusters, respectively.

The slicing of the input feature map may be derived from the slicing of the output feature map, so that the independence among the slicing operations may be ensured. The specific slicing principle may refer to the description of the slicing of the input feature map in conjunction with FIG. 8 as mentioned earlier in the text, and further elaboration is not necessary here.

The aforementioned first dimension may be either the H or W dimension or both, and preferably, the first dimension is a lower dimension in storage order, such as the H dimension, which may reduce the stride of jumping during data access.

From the architecture of the multi-core computing apparatus shown in FIG. 3b, it can be seen that a computing cluster includes one storage core and a plurality of processing cores. Therefore, operations within a same computing cluster may be required to be further sliced onto the plurality of processing cores within it. At this point, the slicing logic may be more refined.

In some embodiments, the master device may further slice the input feature block on the plurality of processing cores within a single computing cluster as follows: based on the size of wo the first dimension of the output feature block corresponding to the input feature block, a slicing method of the input feature blocks on the plurality of processing cores is determined. In other words, depending on whether data along the first dimension (W dimension) can be processed at one time or not, different situations should be handled accordingly.

Broadly speaking, there are several situations that may be considered. For the sake of simplicity in description, in the following text, input feature maps that can be processed at one time in the W dimension may be called “small maps”, input feature maps that can be processed in no more than Ncc rounds in the W dimension may be called “medium maps”, input feature maps that can be processed in exactly Ncc rounds in the W dimension may be called “large maps”, and input feature maps that can be processed in multiples of Ncc rounds in the W dimension may be called “extra-large maps”, where Ncc is the number of processing cores within a single computing cluster. For example, in the illustrative example mentioned earlier, Ncc equals 4.

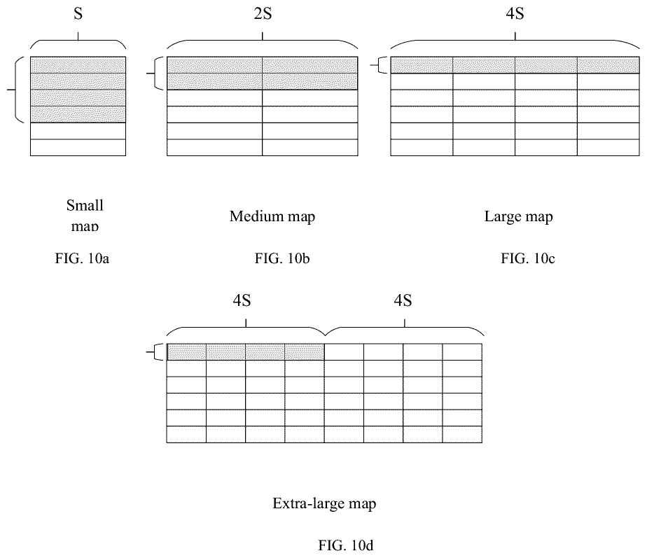

FIG. 10 illustrates a schematic diagram of slicing an input feature block under different conditions according to an embodiment of the present disclosure. As can be inferred from the previous context, the slicing of the input feature blocks is essentially based on the output feature blocks. Therefore, in FIG. 10, each diagram represents the Ho*Wo dimensions of the output feature blocks. The gray part in the diagram represents data loaded into SRAM at the cluster level, and each small cell represents data processed on an individual processing core, which may be referred to as a basic block.

FIG. 10a illustrates a scenario of small maps. For the small maps, since data in the first dimension can be processed at one time, the slicing is not performed from the first dimension but from the second dimension. The second dimension, such as the H dimension, is a higher storage dimension compared to the first dimension.

In these embodiments, the master device may determine the slicing method of input feature blocks on Ncc processing cores as follows: when wo≤S, <Italic> i.e., </Italic> the amount of data that is processed in one core round, the output feature map is sliced into Ncc output feature sub-blocks along the second dimension based on the size ho of the second dimension of corresponding output feature blocks; and based on an input feature region required to compute each output feature sub-block, the input feature blocks are sliced into Ncc input feature sub-blocks along the second dimension correspondingly, and allocated to Ncc processing cores, respectively.

For the example when Ncc=4, 4*1 (H*W) basic blocks may be loaded onto the SRAM at one time, which are allocated to each of the 4 processing cores.

FIG. 10b illustrates a scenario of medium maps. For the medium maps, since the data in the first dimension cannot be processed at one time, but the amount of data in the first dimension is not sufficient to fully saturate or nearly saturate (“fully utilized”) the computation of the Ncc processing cores, data from the second dimension may be supplemented to the first dimension, in other words, slicing may be performed simultaneously along both the first and second dimensions.

In these embodiments, the master device may determine the slicing method of input feature blocks on Ncc processing cores as follows: when

$$S < wo \leq \frac{Ncc}{2} * S ,$$

where S is the amount of data that is processed in one core round, the output feature blocks are sliced into Ncc output feature sub-blocks jointly along the first dimension and the second dimension based on the size ho of the second dimension and the size wo of the first dimension of corresponding output feature blocks, where the output feature blocks are sliced into Ws output feature sub-blocks along the first dimension, the output feature blocks are sliced into Wh output feature sub-blocks along the second dimension, Ws*Wh=Ncc, and the size of the first dimension of each output feature sub-block does not exceed S; and based on an input feature region required to compute each output feature sub-block, the input feature blocks are sliced into Ncc input feature sub-blocks along the first dimension and the second dimension correspondingly, and allocated to Ncc processing cores, respectively.

For the example when Ncc=4, 2*2 (H*W) basic blocks may be loaded onto the SRAM at one time, which are allocated to each of the 4 processing cores.

FIG. 10c illustrates a scenario of large maps. For the large maps, since the data in the first dimension is enough to be processed in Ncc rounds, the slicing may be performed directly based on the first dimension solely.

FIG. 10d illustrates a scenario of extra-large maps. For the extra-large maps, since the data in the first dimension may be processed over multiple rounds on Ncc processing cores, the slicing may be performed directly based on the first dimension solely.

The extra-large maps are similar to the large maps, so the slicing may be performed in a similar manner. In these embodiments, the master device may determine the slicing method of input feature blocks on Ncc processing cores as follows: when wo>Ncc/2*S, the output feature blocks are sliced into m*Ncc output feature sub-blocks along the first dimension based on wo, where m is a natural number, and the size of the first dimension of each output feature sub-block does not exceed S; and based on the input feature region required to compute each output feature sub-block, the input feature blocks are sliced into m*Ncc input feature sub-blocks along the first dimension correspondingly, and allocated to Ncc processing cores, respectively.

For the example when Ncc=4, 1*4 (H*W) basic blocks may be loaded onto the SRAM at one time, which are allocated to each of the 4 processing cores.

In the above embodiment, the slicing strategies of small maps, medium maps, large maps and extra-large maps may be dynamically selected according to the resource situation of the on-chip space. Generally speaking, the size of feature maps processed under a small map mode is about 200*200, the size of feature maps processed under a large map mode is about 960*960, and the size of feature maps processed under an extra-large map mode is about 1080p (1080*1920) and even up to 2K.

Although the above descriptions focus on the slicing strategies for various scales of input feature maps on a plurality of processing cores within a single computing cluster, the aforementioned slicing strategies may also be applied to single-core board cards. As previously mentioned, single-core board cards generally adopt the one storage core+one processing core architecture. Therefore, based on the on-chip space of the storage core, data on a single storage core may be considered as one computational task, which is completed by a single processing core in multiple rounds. A slicing strategy between each round may still follow the strategy described earlier, with the difference being that instead of allocating to Ncc processing cores, the slicing strategy is executed in Ncc core rounds.

Therefore, the slicing strategies may be unified as follows: based on the size wo of the first dimension of the output feature blocks corresponding to the input feature blocks on the storage core, the slicing method of the input feature blocks in Nec core rounds is determined. When a multi-core computing apparatus is used, Nec corresponds to the number of processing cores within a single computing cluster, and typically the capacity of the storage core is sufficient for a single processing round by Ncc processing cores. When a single-core computing apparatus is used, Ncc corresponds to the number of processing rounds executed by a single processing core with the capacity of the storage core.

Similarly, the slicing method in Ncc core rounds may be determined according to the the aforementioned small map mode, medium map mode, and large map mode, as well as different situations, which will not be repeated herein.

In summary, a task slicing scheme in the embodiments of the present disclosure may be flexibly adapted to different board card forms (single-core board cards and multi-core board cards). For example, when computational tasks are allocated, the data volume in a single storage core may be considered as one computational task. Computational tasks of one storage core may be sliced according to the aforementioned slicing strategy to be executed in parallel on different processing cores, or may be divided into multiple rounds in time by a processing core for sequential computations.

The embodiments of the present disclosure also provide a method for allocating and performing the convolution operation using the aforementioned computing apparatus. Those skilled in the art may understand that steps of the method correspond to the various features of the computing apparatus described above in conjunction with the drawings, so the features described above are also applicable to the method steps and will not be repeated herein.

The embodiment of the present disclosure also provides a chip including the computing apparatus of any embodiment described in conjunction with the drawings. Further, the present disclosure also provides a board card including the above-mentioned chip.

According to different application circumstances, the electronic device or apparatus of the present disclosure may include a server, a cloud server, a server computing cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance may include a television, an air conditioner, a microwave oven, a refrigerator, an electric rice cooker, a humidifier, a washing machine, an electric lamp, a gas cooker, and a range hood; and the medical device may include a nuclear magnetic resonance spectrometer, a B-ultrasonic scanner, and/or an electrocardiograph. The electronic device or apparatus of the present disclosure may be further applied to Internet, Internet of Things, data center, energy, transportation, public management, manufacturing, education, power grid, telecommunications, finance, retail, construction sites, medical, and other fields. Further, the electronic device or apparatus of the present disclosure may be used in application circumstances including cloud, edge, and terminal related to artificial intelligence, big data, and/or cloud computing. In one or a plurality of embodiments, according to the solution of the present disclosure, an electronic device or apparatus with high computing power may be applied to a cloud device (such as the cloud server), while an electronic device or apparatus with low power consumption may be applied to a terminal device and/or an edge device (such as a smart phone or the webcam). In one or a plurality of embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device, so as to complete unified management, scheduling, and collaborative work of terminal-cloud integration or cloud-edge-terminal integration.

It is required to be explained that for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be executed in other orders or simultaneously. Further, those skilled in the art may understand that the embodiments described in the present disclosure may be regarded as optional embodiments; in other words, actions and modules involved thereof are not necessarily required for the implementation of a certain solution or some solutions of the present disclosure. Additionally, according to different solutions, descriptions of some embodiments of the present disclosure have their own emphases. In view of this, those skilled in the art may understand that for parts that are not described in detail in a certain embodiment of the present disclosure, reference may be made to related descriptions in other embodiments.

For specific implementations, according to the present disclosure and under the teaching of the present disclosure, those skilled in the art may understand that several embodiments disclosed in the present disclosure may be implemented through other methods that are not disclosed in the present disclosure. For example, for units in the electronic device or apparatus embodiment mentioned above, the present disclosure divides the units on the basis of considering logical functions, but there may be other slicing methods during actual implementations. For another example, a plurality of units or components may be combined or integrated into another system, or some features or functions in the units or components may be selectively disabled. In terms of a connection between different units or components, the connection discussed above in combination with drawings may be direct or indirect coupling between the units or components. In some circumstances, the aforementioned direct or indirect coupling relates to a communication connection using an interface, where the communication interface may support electrical, optical, acoustic, magnetic, or other forms of signal transmission.

In the present disclosure, units described as separate components may or may not be physically separated. Components shown as units may or may not be physical units. The aforementioned components or units may be located in the same position or distributed to a plurality of network units. Additionally, according to actual requirements, some or all of the units may be selected to achieve purposes of the solution described in embodiments of the present disclosure. Additionally, in some circumstances, the plurality of units in the embodiments of the present disclosure may be integrated into one unit, or each of the units may be physically separated.

In some other implementation circumstances, the aforementioned integrated unit may be implemented in the form of hardware. The hardware may be a specific hardware circuit, which may include a digital circuit and/or an analog circuit. A physical implementation of a hardware structure of the circuit may include but is not limited to a physical component, and the physical component may include but is not limited to a transistor, or a memristor, and the like. In view of this, various apparatuses described in the present disclosure (such as the computing apparatus or other processing apparatus) may be implemented by an appropriate hardware processor, such as a CPU (central processing unit), a GPU (graphics processing unit), an FPGA (field programmable gate array), a DSP (digital signal processor), and an ASIC (application specific integrated circuit). Further, the aforementioned storage unit or storage apparatus may be any appropriate storage medium (including a magnetic storage medium or a magneto-optical storage medium, and the like), such as an RRAM (resistive random access memory), a DRAM, an SRAM (static random access memory), an EDRAM (enhanced dynamic random access memory), an HBM (high bandwidth memory), an HMC (hybrid memory cube), an ROM (Read-Only Memory), and an RAM, and the like.

The embodiments of the present disclosure have been described in detail above. Specific embodiments have been used in the specification to explain the principles and implementation manners of the present disclosure. The descriptions of the above embodiments are only used to facilitate understanding of the methods and core ideas of the present disclosure. Persons of ordinary skill in the art may change the implementation and application scope according to the ideas of the present application. In summary, the content of this specification should not be construed as a limitation on the present disclosure.

1. A computing apparatus, comprising a master device and a slave device, wherein the slave device comprises one or more IPU (intelligent process unit) cores, wherein
the master device is configured to issue a first task for performing a convolution operation on input feature data and convolutional kernel data; and
the slave device is configured to schedule an appropriate number of processor cores to execute the first task according to a slicing strategy of the first task, wherein in each core processing round, the convolution operation is performed on a part of the input feature data.

2. The computing apparatus of claim 1, wherein the master device is further configured to determine the slicing strategy of the first task, wherein the slicing strategy is determined by core rounds of processing cores required to complete the first task, as well as the number of input feature blocks required to be processed in each core round.

3. The computing apparatus of claim 2, wherein the master device is further configured to
determine the number of processing rounds L and the number of batches Bi processed in each round based on the total number of batches B of the input feature data and the total number of schedulable processing cores Ncore, wherein i=1, . . . , L, wherein L=ceil (B/Ncore), Σᵢ₌₁^{L}Bi=B=n*Ncore+Brem, wherein n=L−1, and Brem<Ncore.

4. The computing apparatus of claim 3, wherein the master device is further configured to
assign every consecutive n batches of input feature data to a single processing core for processing.

5. The computing apparatus of claim 3, wherein the slave device comprises a plurality of computing clusters, and each computing cluster comprises a plurality of processing cores, wherein the master device is further configured to
distribute Brem batches of input feature data across the plurality of computing clusters for processing, with Nc computing clusters working together to process input feature data of a same batch.

6. The computing apparatus of claim 5, wherein the master device is further configured to
slice output feature data corresponding to the input feature data in a convolution operation into Nc equally shaped output feature blocks along a first dimension; and
slice the input feature data into Nc input feature blocks along the first dimension correspondingly and allocate the sliced Nc input feature blocks to the Nc computing clusters respectively based on an input feature region required to compute each output feature block.

7. The computing apparatus of claim 2, wherein the slave device further comprises one or more storage cores, wherein a storage core provides input feature data to one or more processing cores, and the master device is further configured to distribute input feature blocks on the storage cores across multiple core rounds as follows:
a slicing method of the input feature blocks in the multiple core rounds is determined based on a size wo of the first dimension of output feature blocks corresponding to the input feature blocks.

8. The computing apparatus of claim 7, wherein the master device is further configured to determine a slicing method of the input feature blocks in Ncc core rounds as follows:
when wo≤S, wherein S is the amount of data that is processed in one core round, the output feature blocks are sliced into Ncc output feature sub-blocks along a second dimension based on a size ho of the second dimension of corresponding output feature blocks; and
the input feature blocks are sliced into Ncc input feature sub-blocks along the second dimension correspondingly, and the sliced Nccs input feature sub-blocks are allocated to the Ncc core rounds respectively based on an input feature region required to compute each output feature sub-block.

9. The computing apparatus of claim 7, wherein the master device is further configured to determine the slicing method of the input feature blocks in Ncc core rounds as follows:
when
$$S < wo \leq \frac{Ncc}{2} * S ,$$
the output feature blocks are sliced into Ncc output feature sub-blocks jointly along the first dimension and the second dimension based on the size ho of the second dimension and the size wo of the first dimension of the corresponding output feature blocks, wherein the output feature blocks are sliced into Ws output feature sub-blocks along the first dimension, the output feature blocks are sliced into Wh output feature sub-blocks along the second dimension, Ws*Wh=Ncc, and a size of a first dimension of each output feature sub-block does not exceed S; and
the input feature blocks are sliced into Ncc input feature sub-blocks along the first dimension and the second dimension correspondingly, and the sliced Ncc input feature sub-blocks are allocated to the Ncc core rounds respectively based on the input feature region required to compute each output feature sub-block.

10. The computing apparatus of claim 7, wherein the master device is further configured to determine the slicing method of the input feature blocks in Ncc core rounds as follows:
when
$$wo > \frac{Ncc}{2} * S ,$$
the output feature blocks are sliced into m*Ncc output feature sub-blocks along the first dimension based on the wo, and the size of the first dimension of each output feature sub-block does not exceed S; and
the input feature blocks are sliced into m*Ncc input feature sub-blocks along the first dimension correspondingly, and the sliced m*Ncc input feature sub-blocks are allocated to the Ncc core rounds successively based on the input feature region required to compute each output feature sub-block.

11. The computing apparatus of claim 7, wherein
when there is only a single schedulable processing core in the slave device, the multiple core rounds refer to multiple processing rounds that are sequentially executed by the single processing core over time; and/or
when there are multiple schedulable processing cores in the slave device, the multiple core rounds refer to multiple processing rounds that are executed by the multiple processing cores in parallel over time.

12. The computing apparatus of claim 6, wherein the first dimension is a width dimension W, the second dimension is a height dimension H, and the first dimension has a lower order in storage sequence than the second dimension.

13. The computing apparatus of claim 1, wherein each processing core is configured to apply a Forward4 convolution operation scheme to an input feature sub-block assigned to a current core round to perform the convolution operation.

14. A chip, comprising the computing apparatus of claim 1.

15. A board card, comprising the chip of claim 14.

16. A method for processing data using the computing apparatus of claim 1.
